(19) United States
(12) Patent Application Publication
(10) Pub. No.: US 2026/0161347 A1
(43) Pub. Date: Jun. 11, 2026

(54) SYSTEMS, METHODS, AND COMPUTER-READABLE MEDIA FOR SYNCHRONIZING AUDIO OVERLAYS IN A MEDIA ASSET

(71) Applicant: Adeia Guides Inc., San Jose, CA (US)

(72) Inventors: Zhiyun Li, Kenmore, WA (US); Ning Xu, Irvine, CA (US); Aldis Sipolins, Somerville, MA (US)

(21) Appl. No.: 18/973,735

(22) Filed: Dec. 9, 2024

(51) Int. Cl. G06F 3/16

(52) U.S. Cl. CPC G06F 3/165

(57) ABSTRACT

A client device receives a media asset that has first and second audio portions and receives metadata indicating start and end times for each of the audio portions. A modified version of the media asset with audio overlays based on features of the respective audio portions is played if it determined that the media asset has played at the client device or at another device associated with a user profile at least a threshold number of times. The modified version may be played by playing by a first audio player instance the first audio overlay and by playing by a second audio player instance the second audio overlay. The first and second audio player instances may be accessed in an audio player pool that has a set of audio player instances managed at the client device. Also, a server device may provide such and other functionality.

### BACKGROUND

The present disclosure relates to the creating audio content and, more particularly, to generating audio overlays for media assets that provide variety and user engagement.

### SUMMARY

When content, such as an advertisement or short-form clip having both video and audio components, is provided to a user device, the video and audio components have often been pre-mixed into a single file prior to sending the content to the user device. The user device then receives and plays back the single, pre-mixed file to a user. While generally effective, there may be instances where such pre-mixed, single file approach is inadequate. For example, if one or more portions of the content are to be modified, e.g., in real time, it is challenging to modify such portion(s) of the pre-mixed file in a manner that results in a cohesive, coordinated playback of the modified content.

Curating a collection of available legacy media assets, such as films, TV shows, media content recommendations or other advertisements, short-form clips, or other video or audio assets, presents technological problems, including the need to make each media asset more useful and engaging for users, even after a user has repeatedly consumed the same media asset. Another technological problem is how to present media assets so as to avoid wasting server processing power and other computing resources rendering media assets or webpages with unwanted media content.

In one approach, an audio player software application may play an audio overlay to provide alternative audio for a segment of the media asset. Each launch of an audio player on a device may require computing resources and may introduce latency in playback or transmission. Machine learning (ML) models may be used to update or otherwise alter aspects of media assets for individual users. However, using such ML models to re-purpose major aspects of legacy media assets in a manner that continues to keep each media asset fresh may be computing resource and network resource intense and may introduce undue latency. Also, altering a media asset so that the altered product does not stray from the parameters contemplated by the media asset creators or publishers presents a technological challenge.

A technological solution provided according to an aspect of the present disclosure is using a pool of audio player instances to provide an audio overlay, such as the music or snippets of background noises or sounds, of a media asset. For example, when a previously played media asset is retransmitted to the same user device, or replayed by the same user device, or is rebroadcast to, or replayed, by another user device associated with the same user profile, an audio player instance in the pool may play an audio overlay for a segment of the media asset based on an audio file with relevant audio content. The audio player instance may then be released to the pool of audio player instances and may, as needed, later play another audio overlay, including in a further segment of the same media asset. The audio player may be a software application, such as a media player, that plays an audio data file. In this way, in some embodiments, audio overlays may be played for the media asset on the fly as needed by audio player instances taken from the audio player pool and used/re-used for the media asset. Generative artificial intelligence (AI), such as a trained ML model, may be used to generate alternative audio data files such that the alternative audio may maintain the emotional effect (e.g., the genre of music or mood evoked by the sound) of the original audio created by the creators of the media asset.

The media asset may include video data or may comprise no video data. The media asset may include baseline audio content or no original audio content. Thus, while the audio overlay is sometimes described as replacing the original audio content, it will be understood that if the media asset does not have audio for the time slot indicated, then the audio overlay may not be replacing an original audio of the media asset. The metadata may indicate a time interval in the media asset for which the audio overlay is to be generated, as well as some key words for generating an appropriate audio overlay suitable for the media asset. In some implementations, the audio overlays may be generated server-side and streamed or downloaded as part of, or in association with, the media asset for which it is designated. In some implementations, the ML model may reside on client-side equipment streaming or downloading content from an online media platform.

Two or more audio content items may each be replaced in the same media asset in this way by separate, different audio overlays. In some embodiments, each audio overlay may be played in sequence at the appropriate time in the media asset by the same audio player instance. The audio overlay may be inserted so as to commence at the start time, in the media asset, of the original audio and to end at the end time, in the media asset, of the original audio. For example, a first original audio may extend at a first time interval, starting at time 0.3 seconds until time 12.3 seconds of the media asset, and a second original audio may be extend at a second time interval, starting at time 13.0 seconds until time 25.0 seconds of the media asset; when the media asset is replayed, the first audio overlay may be played during the first time interval and a second alternative audio file may be played during the second time interval. The audio overlay may be inserted so that the audio fades in and/or fades out at or near the starting and ending times, respectively.

Metadata associated with the media asset may be provided asynchronously, provided synchronously or asynchronously, for example, ahead of the media asset. The metadata may describe the genre, style or emotional effect of the original audio data, and this description may be fed to the ML model as a text prompt for generating the audio overlay. In addition, or instead, audio features, for example, the timber, pitch, and the like of the original audio may be automatically identified and used to generate the audio overlay. In some embodiments, alternative audio data may be retrieved from existing sources, such as from a media asset library or an online source.

Metadata associated with the media asset may specify a number of factors for an original audio or for a time interval during which audio may be inserted, such as:
whether an original audio data is replaceable by alternate audio;
a length of the alternative audio needed, or a range of acceptable lengths for the alternative audio needed;
   a start time, or a range of acceptable start times, and an end time, or a range of acceptable ending times, for the original audio data;
one or more descriptive words (e.g., crackling fire, gentle rain falling on a rooftop, a thunderous waterfall, people sneezing, an a cappella Christmas carol choir, or more generically, soft classical music) that may be used to prompt the generation of, or the search for, the audio overlay;
how much stylistic variation from the original audio may be allowed for the alternative audio data;
whether audio generated based on the alternative audio file may be played simultaneously with the original audio (e.g., on top of the original audio), or simultaneously with a portion of the original audio (e.g., played as the original audio fades out or played instead of the second half of the time interval originally allotted for the original audio);
after how many initial repeated consumptions of the media asset the original audio is to be replaced; and
how many times the media asset is to be consumed by a user before a first audio overlay is to be replaced by a second alternative audio file that needs to be generated or otherwise obtained.

The system may generate one or more new audio overlays to replace the original audio overlay each time the media asset is played, or the system may generate the audio overlay upon the expiration of a predefined period or after a set number of plays of the media asset. In some implementations, the same trained generative ML model may be used to generate the first, second, third, etc. audio overlays to yield distinct audio overlays each time because typically, a generative ML model may vary the output it creates even when its prompt is identical. In some embodiments, a second audio overlay may be generated based on the same prompt used to generate the first audio overlay or may be searched for based on attributes identified in the first audio overlay. For example, audio feature extraction may be used to identify attributes (e.g., timber, pitch, etc.) of the first audio overlay, and the identified attributes may be used to prompt a trained ML model to generate the second audio overlay, or may be used to search for the second audio overlay.

Each audio overlay may be a distinct alternative audio content played by a different audio player instance. After an audio player instance finishes playing the alternative audio content item, it may be released into the pool of audio player instances, before playing another alternative audio overlay at a later point in the media asset. By recycling audio player instances, central processing unit (CPU) and other computing resources required to generate a new audio player instance may be conserved and thus latency in providing alternative audio while the media asset is being replayed may be mitigated.

In some embodiments, audio overlays may be cached after they are generated so that periodically (e.g., once a week, every other week, or the like) they may be later recycled for play as part of the same media asset or may be later recycled for play after a predefined number of plays of the media asset. For example, the original audio may be played the first three times the media asset is played, then the system may generate a first alternative audio file when the media asset is played the 4th-6th time, then may generate a second alternative audio file when the media asset is played the 7th-9th time, then play the original audio again when the media asset is played the 10th-11th time, and so on. Or, play of the original audio and the one or more audio overlays may be varied for each play of the media asset pursuant to a random or pseudorandom rotation. Audio overlays may be cached for use in other media assets. For example, soft, jazzy mood music may later be used in one or more additional media assets for which such audio is needed.

User satisfaction, for example, gauged by user reaction data, may be used to determine whether to repeat play of the media asset with the original audio content item, with an audio overlay previously played with the media asset, or with a new audio overlay. For example, if the system determines user engagement with the media asset, for example, user input increasing the volume is detected, user input repeating some or all of the media asset is detected, user gaze data (e.g., an extended reality [XR] device, such as a head mounted device [HMD] detects eye movement) is detected focusing on the media asset, user reaction such as “likes” or “thumbs up” for the media asset is detected, sharing the media asset with friends is detected, or the like, then upon the next transmission or user-initiated repetition of the media asset, or the relevant portion thereof, the system may play the media asset with the audio for which the most user satisfaction was determined.

A method, system, non-transitory computer-readable medium, and means for implementing the method are disclosed for generating graphics. Such a method may be performed by one or more computing devices or systems in a server side and/or a client side configuration. Such a system may include, or be configured as part of, a client device associated with a profile and including a memory and control circuitry, wherein the control circuitry is configured to: receive, from a server, a media asset that has a first audio portion and a second audio portion; receive, from the server, metadata related to the media asset, such that the metadata indicates a first start time and a first end time for the first audio portion within the media asset, and such that the metadata indicates a second start time and a second end time for the second audio portion within the media asset, and to store the metadata in the memory; determine to play a modified version of the media asset comprising a first audio overlay and a second audio overlay based at least in part on determining that the media asset has played at the client device or another device associated with the profile at least a threshold number of times, and wherein the first and second overlays are based at least in part on features of the first and second audio portions, respectively; play a modified version of the media asset by: playing by a first audio player instance the first audio overlay at the first start time indicated in the metadata, wherein the first audio player instance is accessed in an audio player pool managed at the client device, and wherein the audio player pool comprises a plurality of audio players instances; and playing by a second audio player instance the second audio overlay at the second start time indicated in the metadata, wherein the second audio player instance is accessed in the audio player pool.

In such a system, the second audio player instance may be instantiated based at least in part on determining that the second start time occurs between the first start time and the first end time. For each respective audio player instance in the audio player pool, after the respective audio player completes playing a respective audio overlay, the respective audio player instance may remain accessible from the audio player pool for subsequent use for the media asset. For example, the first and second audio player instances may be instantiated based at least in part on determining that the playing of the modified version of the media asset started prior to receiving at least one of the first audio overlay or the second audio overlay.

The first audio overlay or the second audio overlay may be retrieved from storage of the client device. Playing the modified version of the media asset may entail playing a third audio overlay, such that the third overlay is also included in the media asset prior to the modifying of the media asset.

Also contemplated is a system that may include a server that includes a memory and control circuitry configured to provide, to a client device associated with a profile, a media asset comprising a first audio portion and a second audio portion; provide, to the client device, metadata related to the media asset, wherein the metadata indicates a first start time and a first end time for the first audio portion within the media asset, and wherein the metadata indicates a second start time and a second end time for the second audio portion within the media asset; and determine to play a modified version of the media asset comprising a first audio overlay and a second audio overlay, wherein the first and second audio overlays are provided from the server to the client device based at least in part on determining, according to data stored in the memory, that the media asset has played at the client device or another device associated with the profile at least a threshold number of times, and wherein the first and second overlays are based at least in part on features of the first and second audio portions, respectively; wherein the client device is configured to play a modified version of the media asset by: playing by a first audio player instance the first audio overlay at the first start time indicated in the metadata, wherein the first audio player instance is accessed in an audio player pool managed at the client device, and wherein the audio player pool comprises a plurality of audio players instances; and playing by a second audio player instance the second audio overlay at the second start time indicated in the metadata, wherein the second audio player instance is accessed in the audio player pool.

Such a system may be configured to: access a style attribute of an audio content of the media asset; and generate, using one or more trained generative machine learning (ML) models, the audio overlay based at least in part on the style attribute of the audio content. The style attribute may include a descriptive key word, such that descriptive key word is used as part of an input vector for the one or more ML models. The system may determine the style attribute of the first audio portion of the media asset by audio feature extraction from the first audio portion of the media asset.

Such a system may be configured to: access a repetition threshold indicating a number of times the media asset is to be transmitted unmodified to the client device; access a repetition parameter indicating a number of times the media asset has been transmitted unmodified to the client device; and determine, based on the repetition threshold and the repetition parameter, to modify the media asset. For example, the repetition parameter may indicate a second number of times the media asset is to be caused to be played with the first audio overlay for the media asset, and the system may be configured to: determine, based at least in part on the second number of times, to retrieve another audio overlay for the media asset; and retransmit to the client device the media asset and the other audio overlay, wherein the other audio overlay is played by the client device based at least in part on the first start time and the first end time.

The system may access in metadata associated with the media asset date related to various things, for example: a repetition parameter indicating a number of times the media asset is to be transmitted unmodified to the client device, a repetition threshold indicating a number of times the media asset has been transmitted to the client device, and a style attribute indicating a content description of the first audio portion in the media asset in an unmodified state.

The system may determine user engagement with the transmission; and based at least in part on the determined user engagement, select for causing to be played according to the first start time and the first end time, the first audio portion, the first audio overlay, or another audio overlay.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A-1B illustrate an example of audio overlays of a media asset that have replaced the original audio content of the media asset when the media asset is consumed again on a subsequent occasion, according to an example of an aspect of some embodiments of the present disclosure;

FIG. 2 illustrates an example of metadata associated with a media asset that sets parameters of audio content and provides textual descriptions thereof, in accordance with some embodiments of the disclosure;

FIG. 3 illustrates an example of audio player instances of a pool of audio player instances that play audio overlays for time slots of the media asset, in accordance with some embodiments of the disclosure;

FIG. 4 illustrates an example of feature extraction and compilation, in accordance with some embodiments of the disclosure;

FIG. 5 illustrates an example of system interactions between a user device, a digital human generating platform and another node, such as a third party, in accordance with some embodiments of the disclosure;

FIG. 6 illustrates an example of a digital human platform providing a humanized AI agent or other digital human for content from another server, such as the metaverse, in accordance with some embodiments of the disclosure;

FIG. 7 illustrates an example of system interactions for requesting and generating a virtual assistant, in accordance with some embodiments of the disclosure; and

FIG. 8 illustrates a computer system for implementing methods described herein, according to an example of an aspect of some embodiments of the present disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

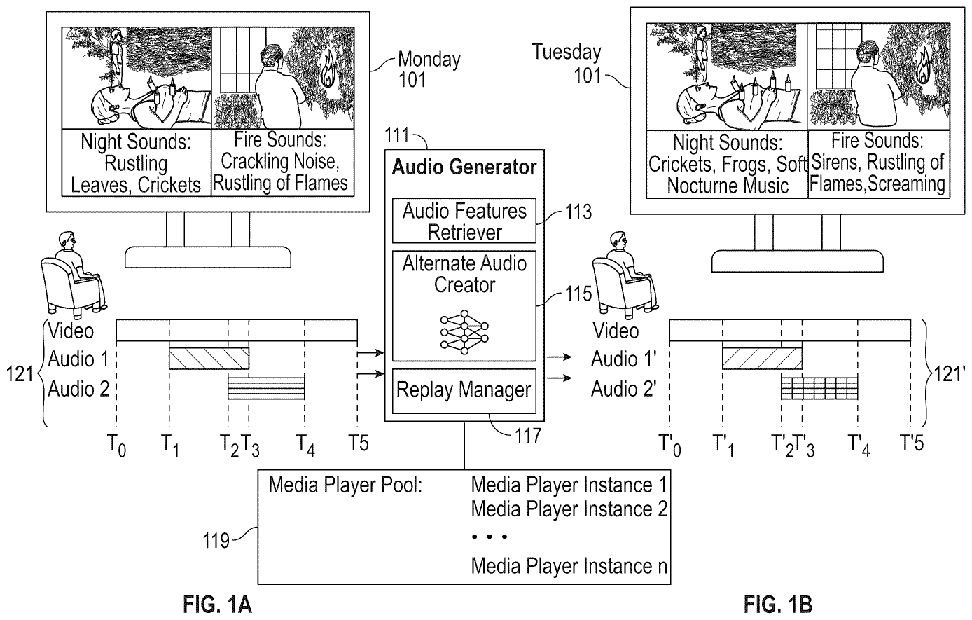

FIGS. 1A and 1B illustrate providing a user with a modified version of a media asset 121′ that is playing at a later time than media asset 121, in accordance with some embodiments of the disclosure. In some embodiments, a media application may be configured to perform the functionalities (or any suitable portion of the functionalities) described herein. The media application may be executed at least in part on computing device 101, and/or at one or more remote servers and/or at or distributed across any of one or more other suitable computing devices, in communication over any suitable type of network (e.g., the Internet). In some embodiments, the media application may be a stand-alone application, or may be incorporated (e.g., as a plugin) as part of any suitable application, e.g., one or more broadcast content provider applications, broadband provider applications, live content provider applications, content provider applications, media asset provider applications, extended reality (XR) applications, e-commerce applications, video or image or electronic communication applications, social networking applications, image or video capturing and/or editing applications, content creation applications, or any other suitable application(s), or any combination thereof.

As shown in FIG. 1A, on Monday, the media application provides for user consumption unaltered media asset 121, which may be a supplemental media content item, such as, for example, an advertisement illustrated in FIGS. 1A-1B (in a non-limiting example) as featuring a night scene and eventually a fire. The unaltered media asset 121 may include video content starting at time T₀ and ending at T₅, as well as original audio content item 1, which may feature soft night sounds, rustling leaves, and crickets, and audio content item 2, which may feature fire sounds, such as crackling noise, and rustling of flames, beginning, respectively, at times T₁ and T₂. Original audio content item 1 and original audio content item 2 may end, respectively, at times T₃ and T₄ of the media asset. Thus, original audio content item 1 extends past the time when the original audio content item 2 begins and therefore there is overlap between the two audios. In some embodiments, the media application may implement audio generator 111 which includes audio features retriever 113, alternate audio creator 115, and reply manager 117, and/or any other suitable components.

In some embodiments, the term “media asset” should be understood to refer to an electronically consumable user assets, e.g., live content, television programming, as well as pay-per-view program, on-demand programs (as in video-on-demand (VOD) systems), Internet content (e.g., streaming content, downloadable content, webcasts, etc.), augmented reality content, extended reality content, augmented reality content, virtual reality content, three-dimensional content, video clips, audio, playlists, websites, articles, electronic books, blogs, social media, applications, games, including video games, and/or any other media or multimedia, and/or a combination of two or more of the above. The media asset may contain video, graphic or image content, or may contain no such content.

Computing device 101 may comprise or correspond to, for example, a mobile device such as, for example, a smartphone or tablet; a laptop computer; a personal computer; a desktop computer; a smart television; a smart watch or wearable device; a camera; smart glasses; a stereoscopic display; a wearable camera; XR glasses; XR goggles; XR head-mounted display (HMD); near-eye display device; a set-top box; a streaming media device; or any other suitable computing device; or any combination thereof.

In some implementations, the player (e.g., provided by the media application) of the media asset may be implemented in an automobile, or other type of vehicle, where the media asset may be radio stream from a traditional station or satellite channel. For example, the media asset may or may not include a visual portion. Music playing as jingles for brands or products, or other sound played as part of the audio stream, for example, as part of a commercial for a product, may be replaced (e.g., after the commercial is repeated a set number of times, the alternative jungle may be played as part of the commercial). The standard jingle may be replaced on-the-fly in real time by alternative media assets.

On subsequent viewing of the media asset (e.g., on Tuesday), the media application may provide for display to the user, as part of media asset 121′, the same video content as was provided for media asset 121, but with one or more different audio content items from what was provided in media asset 121. For example, it may provide audio content item Audio 1′ starting at time T′₁ and ending at T′₃, which may feature night sounds such as crickets, frogs and soft nocturne music; and audio content item Audio 2′ starting at T′₂ and ending T′₄, which may have fire sounds such as sirens, rustling of flames, and screaming, as part of media asset 121′, instead of audio content items audio 1 and audio 2 in media asset 121 being audible. Audio content item Audio 1′ may be an audio overlay played by a media player software application (e.g., a media player instance running on customer premises equipment, such as, for example, on computing 101). Such an audio overlay 1′ may be generated by audio generator 111 based on the features, such as, for example, genre, mood, tempo, word content, musical qualities, instruments used, artist, composer, period of composition, popularity, volume, length, or any suitable combination thereof, and/or other aspects of the original audio content item 1. Similarly, audio content item 2′ may be an alternative audio content item generated by audio generator 111 based on the features of audio content item 2. In this way, the system may provide a fresher, more engaging set of audio content item and, more generally, a more engaging media asset on the second and subsequent viewings. Audio generator 111 may be connected to, or comprised as part of, a Wi-Fi router, a set-top-box (STB), desktop/laptop or other computing device. Alternate audio content creator 115 may be a module that runs a trained generative machine learning (ML) model that generates for output audio content based at least in part on an input vector, such as, for example, corresponding to a text description of the audio content. For example, a textual description of one or more objects or sounds present in media asset 121 may be included in metadata for the media asset, or may be obtained by any suitable computer-implemented technique (e.g., using an image-to-text model, where images of the media asset are fed into the model and a textual description of such images is obtained, and/or by transcribing audio and obtaining a textual description of audio in the media asset, and/or by otherwise identifying certain types of sound or types of images in the media asset). Replay manager 117 may be a module that manages when (e.g., with what frequency of plays of the media asset featuring the same video content) one or more portions of the original audio content and/or generated audio overlay is replayed or replaced.

The system may determine whether a media player instance is available in a media player pool 119, in which case it may set the available player instance to play an audio overlay at the relevant time slot in the media asset. The system may set each media player instance to play a separate audio overlay. If the system determines that no media player instance is available at the time slot in the media asset needed to play the relevant audio overlay, then the system may instantiate a media player instance.

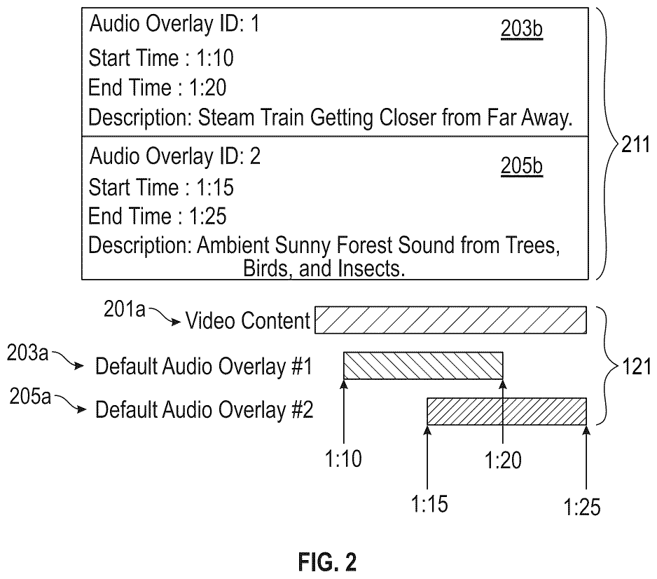

FIG. 2 shows media asset 121 comprising video content 201a and original audio data items 203a and 205c, in accordance with some embodiments of this disclosure. Metadata 211, which may be part of the media asset 121 or may be transmitted or accessed separately therefrom, may include metadata 203b, which pertains to the original audio content item 203a, and metadata 205b, which pertains to the original audio item 205a. Metadata 203b may indicate the start and end times of the audio content 203a in the media asset 121 as well as one or more descriptive words or phrases describing features or qualities of the original audio item 203a. Similarly, metadata 205b may pertain to the original audio item 205a and may indicate the start and end times in the media asset 201 of the original content item 121 as well as one or more descriptive words or phrases describing features or qualities of the original audio item 205a.

The metadata 211 may include: a universally unique identifier (UUID), which may be a 128-bit value, that matches the ID, start and end time of the original audio content of the media asset, and/or any other suitable data. Metadata may be provided for one or more media assets or may be provided separately for each media asset or for each audio content item in each media asset.

In an implementation, a consumer of the media asset does not need to provide input, such as selecting a specific audio track, or the like, to cause generation or playing of an audio overlay (e.g., instead of the original audio content or instead of a previously played audio overlay). The metadata may include a number or range indicating how many times the default audio overlay should repeat before the AI generated variations is to play, or may indicate that the during the first 50 replays of the media asset, the probability that the default audio content, as opposed to the generated audio overlay, is played is gradually changed from 1:0 to 0:1. For example, a random/pseudorandom variable may be multiplied by a weighting factor that gradually increases the odds that the generated audio overlay is played. The metadata may indicate that audio variations may be generated automatically for each play of the media asset without repeating the audio overlay, so that the viewers can keep hearing different variations over time. The metadata may indicate how often to swap out a first generated audio overlay for a second (and third, etc.) generated overlay. For example, each generated audio overlay may be played during three consecutive plays of the media asset, before a new generated audio overlay is used. Relatedly, the metadata may indicate that previously generated audio overlays may be recycled after a specified number of plays of the media asset, or after a period of time, for example, after 3-10 days, or after 1-90 days. Similarly, the original audio content may be recycled after a specified number of plays of the media asset, or after a period of time, for example, after 3-10 days, or after 1-90 days. The metadata may indicate that when or how frequently the audio overlays are varied may be controlled in a completely random/pseudorandom manner. The metadata may specify that the original audio content for a particular slot of the media asset (or all audio content of the media asset) may not be altered. For example, the producer or source of the media asset may request that original audio content only may be played as part of the media asset. In some embodiments, one or more of such factors that control repetition of the original audio content and/or the audio overlay may be set by customer premises equipment.

The metadata may also indicate how much the variations should match the original style. For example, it may indicate that in the first 50 plays of the media asset, style match is changed from 90% similarity to original audio to 10% similarity to original audio. The metadata may specify that some features or aspects of the audio content may be changed while others may not. For example, the metadata may indicate that the genre, mood and/or tempo is to remain unchanged while other features may be changed.

The generation of the alternative audios for a given media asset may be performed on the fly as needed or the generation may be done before and the audio pre-cached. Thus, if generation of the alternate audio content items is still in ongoing when the media asset is played, then one or more new audio overlays may be generated on the fly and timed to play at time slots of the media asset as needed. For example, the system may generate the alternate audio overlays the first time the media asset is played, or the first time alternative audio overlays are needed, and store them for subsequent playing of the media asset. If all the audio content items have been generated before the media asset is played, then they may be combined/mixed before playing. In some implementations, the alternate audio overlays may be generated and/or stored locally, such as at user equipment, or may be generated and/or stored server side.

Some, or all, of the generated alternate audio overlays may be deleted automatically based on a least recently used (LRU) approach to free up memory resources. In some embodiments, audio content may be captured from other media items. For example, audio output from the TV's video player may be analyzed. The audio segment may be compared the with the textual description of the audio content for a time slot of the media asset in a shared embedding space. If a good match is determined, then that audio segment may be extracted as an entry in the audio overlay database. Audio of other media assets may be identified and separated. They may be converted for use as, or as part of, one or more audio overlays.

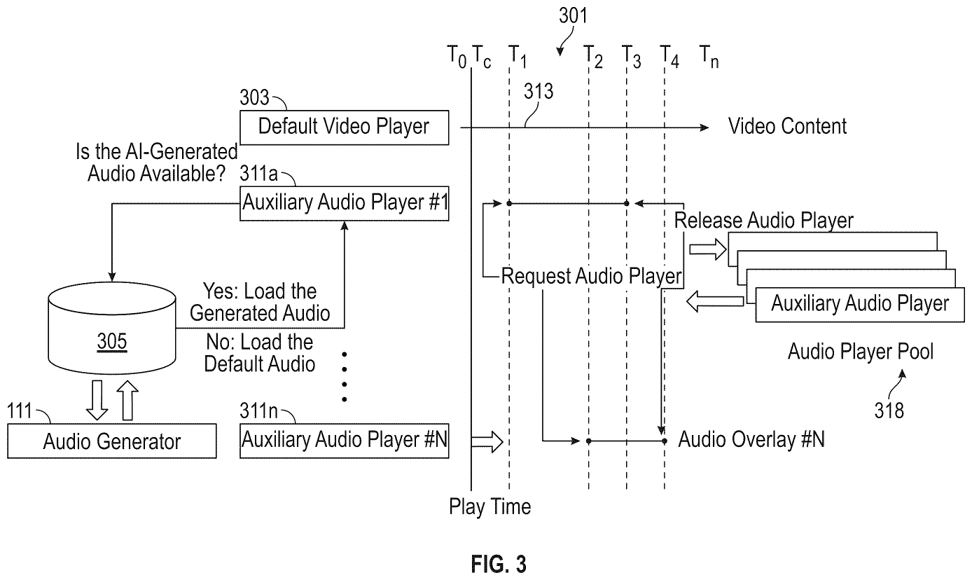

FIG. 3 illustrates an example of audio content items 311a-311n sorted according to their start times, in accordance with some embodiments of this disclosure. The solid vertical line T_{c} (time current or a current time) indicates the current playing timestamp of the media asset 301. As play of the media asset 301 continues, the vertical line T_{c} sweeps from left to right, as indicated by the vertical dashed lines at times T₁, T₂, T₃, T₄, each time representing a timestamp where an audio content item either starts or ends. For example, the first dashed line at T₁ is the timestamp at which the first audio overlay should start. Each audio content item may have a duration different from durations of other content items, so the end time may not be sorted in the same order as the start time.

To facilitate the use of multiple audio players during play of the same media asset, the media application may implement an audio player pool in some implementations to reduce CPU processing time required for providing the modified version of the media asset, e.g., media asset 121′. For example, any of the examples in FIGS. 1-2 may utilize such an audio player pool. In some embodiments, the default media player may be the same one generally used for playing the media asset. However, one or more additional auxiliary audio players, or instances of audio players, may be used, each audio player playing a separate audio overlay content at the specified start and end time of the respective audio overlay content. In some implementations, multiple audio player instances may be employed only when multiple audio overlays are playing concurrently (e.g., when audio content items playing times overlap, such as in FIG. 1 when audio 1′ and audio 2′ are concurrently playing during time T₂-T₃). Therefore, instead of using a fixed number of audio player instances to play a comparable number of audio overlays, an audio player pool may be employed to reuse the audio player instances efficiently.

Before creating a new audio player instance, the system may check whether there is an idling audio player instance in the audio player pool 315. Every time an audio player instance finishes playing an audio overlay, the audio player instance may be released to the audio player pool for later reuse. In such implementations, each time an audio content item starts, a request may be sent to the audio player pool 315. If there is no audio player instance available, then one may be generated. Otherwise, an available idling audio player instance from the audio player pool 315 may be used. When an audio content item ends, instead of closing or ending processing the corresponding instance of audio player, the audio player instance may be set to idle mode and returned to the audio player pool 315 for later use.

To mitigate latency, the media application may launch each audio player earlier to compensate for data loading time, according to some implementations. For example, audio overlays may be cached before play of the media asset reaches the time slot for which the audio overlay is appropriate. Each audio player instance may query the audio database for an ID of the audio content item. Each audio overlay may be associated with a predefined number. Each audio overlay may be associated (e.g., in local memory) with a start time and/or an end time in the media asset. Each audio overlay may be associated with a counter in memory indicating how many times it will be repeated before a different audio overlay is used for the same time slot. If the audio overlay is available in time when the media asset is playing, then that audio player may be loaded with the audio overlay. Otherwise, the original audio content item content may be loaded or used, and the audio generator may be requested to start creating a new audio overlay.

In some embodiments, the media asset may contain no default audio content or may not contain audio content that is to be played in a time slot of the media asset. In some embodiments, the audio content and/or alternate audio overlays may be generated and/or downloaded asynchronously from the media asset. The metadata for generating and repeating audio overlays may be streamed separately (e.g., before the media asset). This may provide flexibility, for example, if the producer or source of the media asset does not include the default audio content, the media content platform may know whether or not the AI generated audio overlay is ready before streaming the media asset.

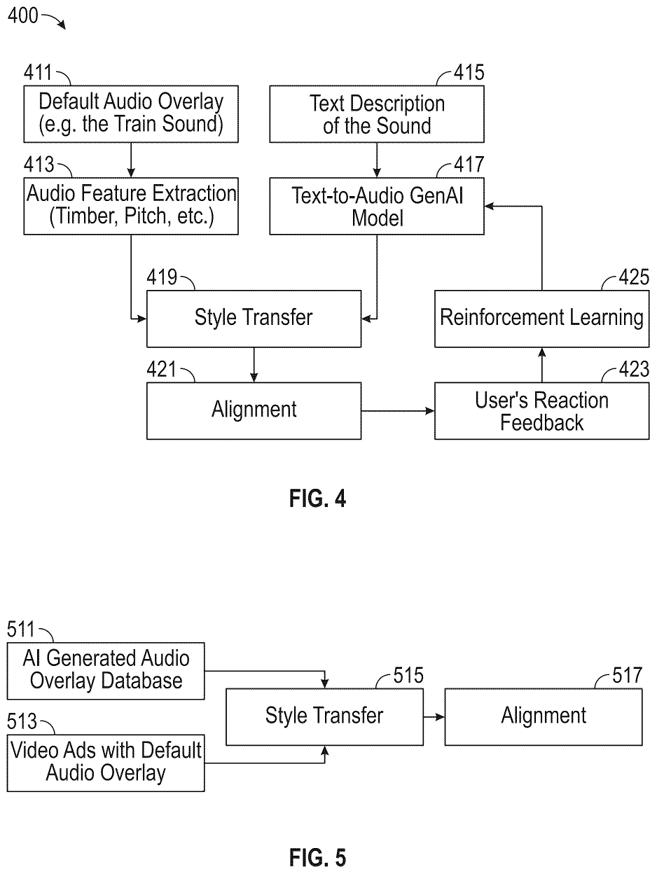

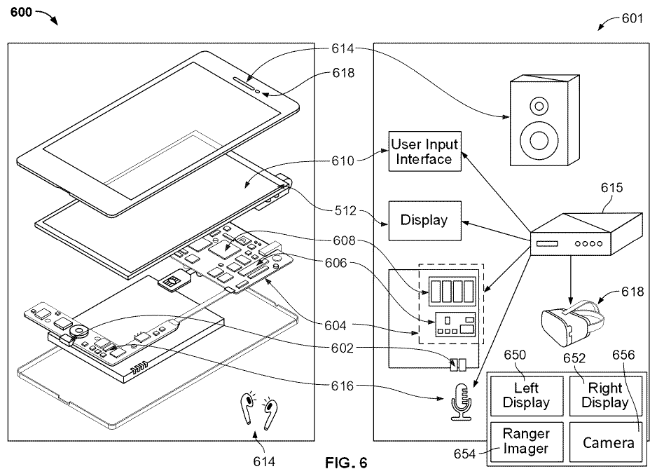

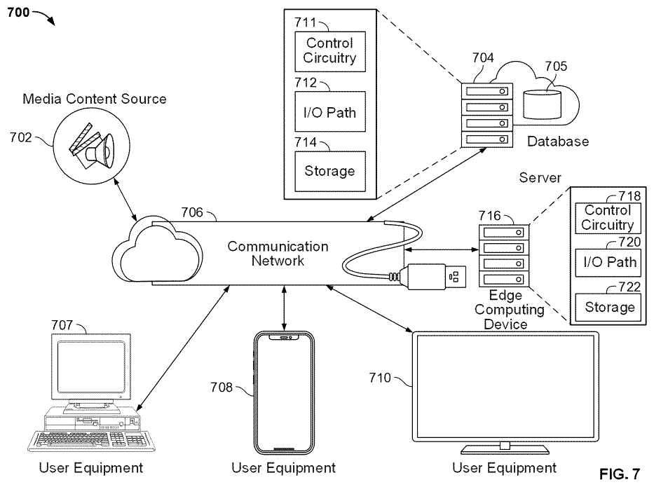

FIG. 4 illustrates an overview of an example of an implementation of a process 400 according to an aspect of the disclosure. One or more actions of the process 400 may be incorporated into or combined with one or more actions of any other process or embodiments described herein. These and other methods described herein, or portions thereof, may be saved to a memory or storage (e.g., of the systems shown in FIGS. 6 and 7) or locally as one or more instructions or routines, which may be executed by any suitable device or system having access to the memory or storage to implement these methods.

At 411, a piece of default audio content, such as a train engine sound, may be received (e.g., a media server may stream a media asset that includes a default audio content) by customer premises equipment, such as a handheld device, a wireless router, or a car radio. Or, the default content may be accessed by an audio customization server that generates audio overlays for transmission to a client device.

At 413, as part of audio feature extraction, a relevant audio portion of a media asset may be automatically analyzed to identify, classify and/or extract various qualities of the default audio portion, such as timber, pitch, volume and the like. One or more software applications for music information retrieval or machine learning techniques may be used to identify or extract the relevant data. In some embodiments, the system may use a music recognition software application to identify a musical composition contained in the default audio content. Once the song or other musical composition is identified, the system may identify and retrieve related songs or other musical compositions (e.g., by the same composer, artist, band, country or region of origin, date or era/period of composition, genre, mood, tempo, musical instrument(s) used or other musical qualities, word content, length, or one or more other such qualities of the musical piece) or the data thus generated at audio feature extraction 413 may be input to the audio overlay generator at 419. In some embodiments, an audio overlay may be generated (e.g., using generative AI) at this point based on the audio features extracted.

Another subprocess is shown at 415-417 for generating data that may be input to the audio overlay generator at 419. This subprocess may be undertaken independently from the subprocess 411-413 or may be performed in addition to it.

At 415, text description of the sound or sounds of a portion of the media asset may be accessed in metadata associated with the media asset, or in metadata associated with one or more audio content items in the media asset, may be accessed. For example, the text description may include one or more words such as soft night sounds, rustling leaves, crickets and frogs to describe audio content, or the like, or for another audio content may include one or more words such as fire sounds, crackling noises, rustling of flames, or the like. Closed captioning or other textual information associated with the media asset may be accessed and used. An audio portion may include more than one sound simultaneously and/or sequentially. For example, a particular default audio portion may contain a sound of a train whistle in the distance, and then the sound of a train as it gets louder to simulate an approaching train getting closer and closer. Each such sound may be described using words in the metadata. The metadata may include time markers for each time slot of the media asset to indicate where in the time slot each sound begins and ends. A separate second time slot with its own audio content may begin a few seconds later in the media asset.

At 417, an audio overlay may be generated (e.g., by a generative AI model) based on the text descriptors of aspects or features of the sound or sounds contained in the metadata at 415, based on other information retrieved from the media asset, or based on information retrieved after a music recognition software application identifies a sound in the original audio content item. Such a descriptor of one or more aspects or features of the sound or sounds contained in the metadata and/or an audio feature of the default or original audio content that is extracted from the default or original audio content may sometimes be referred to herein as a “feature.”

At 419, an audio overlay may be generated based on the text description of the sound or sounds of a portion of the media asset. In some implementations, a different audio player instance may play each audio overlay in the time slot. Generative AI (Gen AI), such as Meta's AudioCraft and Google's AudioLM, or custom implementations thereof, and/or any other suitable computer-implemented techniques, may be used to generate the audio overlay.

As shown at 421 of FIG. 4, the system may generate audio content for later use. For example, a train engine sound may occur in multiple media assets (e.g., advertisements), but with different style and duration. In some implementations, instead of storing the generated audio overlay, the raw sound of the train engine may be stored as the common base. The audio overlay that includes a train engine may then be produced using a degree of style transfer and alignment with the start time of the respective media asset at a later time. Thus, in some implementations, an alternative train engine sound may be generated as the audio overlay by a generative AI model. At 419, the style of the train engine sound may be modified based on the style of the original train sound. The style may incorporate such qualities as pitch, timber, volume, treble and/or bass content, and the like and may set or affect the mood or emotional effect of the audio overlay. This style transfer may be done using the same AI model or one or more additional AI models. The degree of similarity—style transfer—may be varied over time. Thus, the train engine sound may be saved for later uses for the same or different time slots of the media asset. For each play of the train engine sound, the style may be varied, or the style may be varied after a certain number of replays of the media asset. For example, setting a higher percentage of style will make the result more influenced by the chosen style, while a lower percentage preserves more of the original content.

At 421, the audio overlay may be aligned with the time slot of the media asset. One or more audio player instances may be used to play the audio overlay for the time slot set by the metadata. The default audio content may be muted.

As further shown at 423 of FIG. 4, in some embodiments, the system may monitor user feedback or other user reaction to the audio content/audio overlay and/or to the media asset. For example, favorable user reaction may include visiting a website associated with the media asset and/or with one or more products, people or other items mentioned, suggested by or otherwise associated with the audio content/audio overlay and/or to the media asset. For instance, if the media asset is an advertisement for a product, a user may be using a mobile device to consume the media asset and also to visit a website for a product being advertised by the media asset. A user profile associated with the user equipment that is receiving the media asset may be used to track online activity of a user consuming the media asset. A client device may notify a server of consumption by the user of the media asset, including the audio overlay(s) that were consumed therein, and may further notify the server of one or more user reactions detected in connection therewith.

Other indications of user reaction may include user ratings of the media asset and/or of the audio content/audio overlay thereof or products, people or other items mentioned or suggested thereby, user recommendations of the media asset and/or of the audio content/audio overlay thereof or products, people or other items mentioned or suggested thereby, user searching or scrolling for related media assets and/or of the audio content/audio overlay of related media assets, or for products, people or other items mentioned or suggested by the media asset and/or of the audio content/audio overlay thereof, biometric data captured while (or shortly after) the user consumes the audio content/audio overlay and/or to the media asset, including user speech, facial expression, eye gaze (e.g., detected using a camera or using an extended reality [XR] head mounted device ([HMD]), a gesture, heart rate or stress levels, and/or the like, or a combination of two or more of the foregoing. A user reaction metric may be stored in metadata associated with the audio content/audio overlay and/or to the media asset.

As shown at 424, in reinforcement learning step, the system may set a more frequent inclusion of the audio content/overlay that is determined to induce a higher level of user reaction. If the determined user reaction meets or exceeds a reaction threshold, then the audio content/audio overlay may be used again, or may be used more frequently in future plays of the media asset. In some implementations, the reaction metric may be compared with reaction levels determined for alternative audio content/audio overlays to determine which audio induces a higher level of user reaction. The audio content/overlay that is determined to induce a higher level of user reaction may be used again, or may be used more frequently in future plays of the media asset. In some embodiments, the system may implement a feedback loops using an AI model to analyze the relative performance of different audio overlays in the same time slot of the media asset, and may optimize future generations of audio overlays according to one or more of the best performing ones. For example, the system may start with the best performing audio overlay and continue to modify it in successive plays of the media asset in ways that are determined to induce greater user engagement or reaction to the modified media asset. Thus, a second audio overlay may be generated by slight modifications to an earlier audio overlay that was determined to induce a high level of user reaction. For example, if the first audio overlay included jazz and garnered a strong user reaction, the second audio overlay may be generated to include more jazz (e.g., a longer jazz portion, a louder jazz solo). The second audio overlay may be determined to generate an even stronger user reaction in subsequent plays of the media asset than did the earlier audio overlay on which it was based. The second audio overlay may then be further modified in subsequent plays of the media asset to attempt to generate strong user reactions (e.g., even more prominently featured jazz). In some embodiments, other audio overlays of the media asset, or of other media asset, may be modified based on the user reaction detected for the current overlay. Thus, continuing with this example, if the system detects a strong user reaction to the media asset when an audio overlay includes jazz, then other audio overlays of the media asset, or of other media asset, may be generated or modified to include jazz more prominently.

In some embodiments, the system may utilize real-time data, such as user engagement metrics or environmental factors (e.g., time of day, location, weather, season, event) to adjust audio overlays dynamically. For example, the system may incorporate ambient sounds relevant to the user's geographic location (e.g., city noises for urban users, nature sounds for rural areas) to give the user the feeling that the media asset is timely and relevant to the user.

An audio overlay may be synchronized with smart home devices, for instance, smart bulbs, for a multisensory experience, in some embodiments. For example, the system may adjust the lights of a room to a brighter setting when playing a more upbeat generated audio overlay with a faster tempo. The system may adjust the lights to bluer or cooler color setting when playing a jazzier audio overlay. An audio overlay may be synchronized with one or more visual elements in a spatial audio or surround sound way, in some embodiments. In this way, the audio overlays may be played back in different speakers differently, according to the specific visual cues in the media asset.

In some embodiments, the system may enable users or influencers to create their own audio overlays for ads or other media assets. For example, the system may prompt a user to select music for an audio overlay with a faster tempo or a slower tempo, or with more or less music, with more or less classical music, or the like. Or, the system may enable users or influencers to create their own audio overlays for media asset, or to integrate snippets from their songs or music to enhance the appeal of the media asset.

In AI-based style transfer, the degree of style blending, which may be expressed as a percentage, may be controlled. Style transfer may be used to control the degree of similarity to the original audio needs to be preserved.

As shown in FIG. 5, one or more “raw” sounds accessed at 511 in an AI generated audio overlay database or at 513 in the original audio content of a media asset may be modified at 515 in a style transfer step. By adjusting the balance between hewing close to the original content and “style” losses in the process used to generate the alternative audio overlays, the system may determine the degree to which the original content's structure or features are to be retained versus how much of the style is transferred over. For example, setting a higher percentage of style may make the result more influenced by the chosen style, while a lower percentage may preserve more of the original content.

At 517, the finalized audio overlay is aligned with a time slot in the media asset for which it is intended. Alignment may entail setting a media player instance to the start and end times for the audio overlay in the media asset. Alignment may entail generating a fading in/fading out of the audio overlay, an extension of the length (e.g., at the beginning and/or at the end) of the audio overlay or the like.

FIG. 6 illustrates an example of generalized embodiments of illustrative user equipment devices 600 and 601. For example, user equipment device 600 may be a smartphone device, a tablet, a virtual reality or augmented reality device, or any other suitable device capable of processing video data. In another example, user equipment device 601 may be a user television equipment system or device. User equipment device 601 may include set-top box 615. Set-top box 615 may be communicatively connected to microphone 616, audio output equipment (e.g., speaker or headphones 614), and display 612. In some embodiments, display 612 may be a television display or a computer display. In some embodiments, set-top box 615 may be communicatively connected to user input interface 610. In some embodiments, user input interface 610 may be a remote-control device. Set-top box 615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path.

Each one of user equipment device 600 and user equipment device 601 may receive content and data via input/output (I/O) path 602 that may comprise I/O circuitry (e.g., network card, or wireless transceiver). I/O path 602 may provide content (e.g., broadcast programming, on-demand programming, Internet content, content available over a local area network (LAN) or wide area network (WAN), and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing. For example, set-top box 615 may be replaced by, or complemented by, a personal computer (e.g., a notebook, a laptop, a desktop), a smartphone, a tablet, a network-based server hosting a user-accessible client device, a non-user-owned device, any other suitable device, or any combination thereof.

Control circuitry 604 may be based on any suitable control circuitry such as processing circuitry 606. As referred to herein, control circuitry 604 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 604 executes instructions stored in memory (e.g., storage 608). Specifically, control circuitry 604 may be instructed to perform the functions discussed above and below.

In client/server-based embodiments, control circuitry 604 may include communications circuitry suitable for communicating with a server or other networks or servers. Applications may be a stand-alone application implemented on a device or a server. Applications may be implemented as software or a set of executable instructions. The instructions for performing any of the embodiments discussed herein may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a device 600.

In some embodiments, applications may be a client/server application where only the client application resides on device 600 (e.g., device 104), and a server application resides on an external server. For example, an application may be implemented partially as a client application on control circuitry 604 of device 600 and partially on server 604 as a server application running on control circuitry 611. Server 604 may be a part of a local area network with one or more of devices 600 or may be part of a cloud computing environment accessed via the internet. In a cloud computing environment, various types of computing services for performing searches on the internet or informational databases, providing AR generation, providing storage (e.g., for a database) or parsing data (e.g., using machine learning algorithms described above and below) are provided by a collection of network-accessible computing and storage resources, referred to as “the cloud.” Device 513 may be a cloud client that relies on the cloud computing capabilities from server 501, 531 to determine whether processing (e.g., at least a portion of virtual background processing and/or at least a portion of other processing tasks) should be offloaded from the mobile device, and facilitate such offloading. When executed by control circuitry of server, applications may instruct control circuitry to perform processing tasks for the client device and facilitate audio overlay generation.

Control circuitry 604 may include communications circuitry suitable for communicating with a server, edge computing systems and devices, a table or database server, or other networks or servers The instructions for carrying out the above mentioned functionality may be stored on a server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as AR application data described above (e.g., database 420). Nonvolatile memory may also be used (e.g., to launch a boot-up routine and other instructions). Cloud-based storage may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of user equipment 600. Control circuitry 604 may also include digital-to-analog converter circuitry and analog-to-digital converter circuitry for converting between digital and analog signals. The tuning and encoding circuitry may be used by user equipment device 600, 601 to receive and to display, to play, or to record content. The tuning and encoding circuitry may also be used to receive video AR generation data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment device 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment device 600 and user equipment device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 615.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of device 600 and equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. AR display device 618 may be any suitable AR display device (e.g., an integrated head mountain display or AR display device connected to a system 600). In some embodiments all elements of system 600 may be places into housing of the AR display device 618. In some embodiments, AR display device 618 comprises a camera (or a camera array) 656. Video cameras 656 may be integrated with the equipment or externally connected. One or more of cameras 656 may be a digital camera comprising a charge-coupled device (CCD) and/or a complementary metal-oxide semiconductor (CMOS) image sensor. One or more of cameras 656 may be an analog camera that converts to digital images via a video card. In some embodiments, one or more of cameras 656 may be dirtied at outside physical environment (e.g., two cameras may be pointed out to capture to parallax views of the physical environment). In some embodiments, one or more of cameras 656 may be pointed at user's eyes to measure their rotation to be used as biometric sensors. In some embodiments, AR display device 618 may comprise other biometric sensor or sensors to measure eye rotation (e.g., electrodes to measure eye muscle contractions). AR display device 618 may also comprise range image 654 (e.g., LASER or LIDAR) for computing distance of devices by bouncing the light of the objects and measuring delay in return (e.g., using cameras 656). In some embodiments, AR display device 618 comprises left display 650, right display 650 (or both) for generating VST images, or see-through AR images.

The AR application may be implemented using any suitable architecture. For example, it may be a stand-alone application wholly-implemented on each one of user equipment device 600 and user equipment device 601. In such an approach, instructions of the application may be stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to provide functionality and perform any of the actions discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, applications may be downloaded and interpreted or otherwise run by an interpreter or virtual machine (run by control circuitry 604). In some embodiments, the AR application may be encoded in the ETV Binary Interchange Format (EBIF), received by control circuitry 604 as part of a suitable feed, and interpreted by a user agent running on control circuitry 604. For example, the AR application may be an EBIF application. In some embodiments, the AR application may be defined by a series of JAVA-based files that are received and run by a local virtual machine or other suitable middleware executed by control circuitry 604. In some of such embodiments (e.g., those employing MPEG-2 or other digital media encoding schemes), the AR application may be, for example, encoded and transmitted in an MPEG-2 object carousel with the MPEG audio and video packets of a program.

FIG. 7 is a diagram of an illustrative system 700, in accordance with some embodiments of this disclosure. User equipment devices 707, 708, 710 (e.g., which may correspond to one or more of computing device 212 may be coupled to communication network 706. Communication network 706 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 706) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 706.

System 700 may comprise media content source 702, one or more servers 704, and one or more edge computing devices 716 (e.g., included as part of an edge computing system). In some embodiments, applications may be executed at one or more of control circuitry 711 of server 704 (and/or control circuitry of user equipment devices 707, 708, 710 and/or control circuitry 718 of edge computing device 716). In some embodiments, data structure 211 of FIG. 2, may be stored at database 705 maintained at or otherwise associated with server 704, and/or at storage 722 and/or at storage of one or more of user equipment devices 707, 708, 710.

In some embodiments, server 704 may include control circuitry 711 and storage 714 (e.g., RAM, ROM, Hard Disk, Removable Disk, etc.). Storage 714 may store one or more databases. Server 704 may also include an input/output path 712. I/O path 712 may provide audio overlay generation data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 (and specifically control circuitry) to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i9 processors) or multiple different processors (e.g., an Intel Core i7 processor and an Intel Core i9 processor). In some embodiments, control circuitry 711 executes instructions for an emulation system application stored in memory (e.g., the storage 714). Memory may be an electronic storage device provided as storage 714 that is part of control circuitry 711.

Edge computing device 716 may comprise control circuitry 718, I/O path 720 and storage 722, which may be implemented in a similar manner as control circuitry 711, I/O path 712 and storage 724, respectively of server 704. Edge computing device 716 may be configured to be in communication with one or more of user equipment devices 707, 708, 710 and video server 704 over communication network 706, and may be configured to perform processing tasks in connection with ongoing processing of video data. In some embodiments, a plurality of edge computing devices 716 may be strategically located at various geographic locations, and may be mobile edge computing devices configured to provide processing support for mobile devices at various geographical regions.

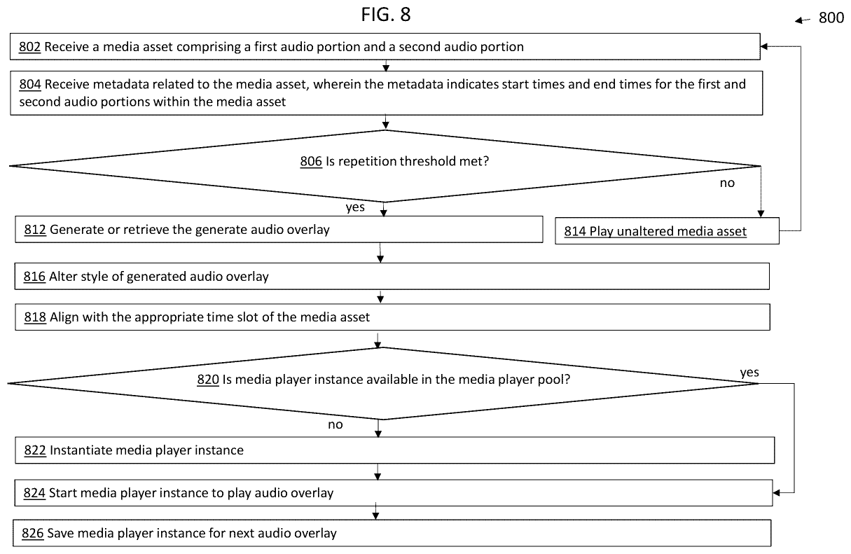

FIG. 8 is a flowchart illustrating an example of a process 800 for playing generated audio overlays by media player instances, according to an aspect of the present disclosure. One or more actions of the method 800 may be incorporated into or combined with one or more actions of any other process or embodiments described herein. These and other methods described herein, or portions thereof, may be saved to a memory or storage (e.g., of the systems shown in FIG. 6 or 7) or locally as one or more instructions or routines, which may be executed by any suitable device or system having access to the memory or storage to implement these methods.

At 802, the control circuitry (e.g., control circuitry 604 of FIG. 6 and/or control circuitry 711 of FIG. 7) and/or I/O circuitry 603 of FIG. 6 and/or I/O circuitry 712 of FIG. 7, may receive a media asset (e.g., media asset 121 of FIG. 1) comprising one or more audio portions, for example, a first audio portion and a second audio portion. On the client side, user equipment may receive from a media server an advertisement as a media asset 121. On a server side, a media server may access a database that comprises media assets that include audio portions and may transmit the media assets to a client side device.

At 804, client device may receive metadata related to the received media asset. The metadata may indicate start an end times for the first and second audio portions within the media asset. The metadata may also include repetition thresholds, indicating how many repetitions, or the frequency of repetitions, or the like for one or more audio content items of the media asset. The repetition parameter may also indicate a sequence of probabilities over time, or over a number of repeated consumptions of the media asset, that a new audio overlay will be played for a time slot of the media asset. In some embodiment, metadata may be transmitted as part of the media asset, or as part of the streaming of the media asset. Or, the metadata may be transmitted, asynchronously, for example, before or before or after the media asset is streamed. For example, if the media assets are advertisements that are to be played during a TV show that is being streamed, metadata for a number of such media assets may be transmitted at the beginning of the streaming of the TV show. In some embodiment, video data portions may be separately transmitted from audio data content. If implemented on the server side, the media assets and related metadata may be accessed from one or more databases and transmitted to the client device.

At 806, a repetition threshold is checked to determine whether the original/default audio content of the media asset is to be repeated or whether an alternative audio overlay is to be played during playing of the media asset.

If it is determined that the repetition threshold is not met then, at 814, the default or original audio content may be played.

On the other hand, if it is determined that the repetition threshold is met then, at 812, an audio overlay (e.g., audio 1′ shown in FIG. 1) maybe generated or retrieved. Simultaneously with the generation of the audio overlay at 812, or before or after this step, the system may determine whether a media player instance is available in a media player pool. If no media player instance is available, the system may instantiate a media player. This determination may be made before or after step 812.

At 816, the style of the audio overlay may be altered depending on a style alteration parameter. The style alteration parameter may be specified in the metadata according to preferences of the producer or source of the media asset. For example, a raw generated audio overlay, may be further modified according to the style threshold parameter to generate the audio overlay.

At 818, the audio overlay may be aligned with the appropriate time slot of the media asset for which it is intended. To do this, the media player instance may be set to start playing at a time synchronized with the intended time slot of the media asset.

At 820, the system may determine whether the media player instance is available in the media player pool for playing this audio overlay at the time slot in the media asset. As discussed, this may be determined earlier in the process shown in FIG. 8.

If no media player instance is available then, at 822, the system may instantiate a media player instance.

On the other hand if a media player instance is available in the media player pool for playing the audio overlay at the time indicated time slot of the media asset then processing may move to 824: the media player instance may start playing the audio overlay (e.g., audio 1′ in its slot in the media asset or audio 2′ in its slot in the media asset) or may be set to start playing the audio overlay later at the time slot indicated.

If a media player has been instantiated at 822, then processing moves from 822 to 824.

As shown at 826, after the media player instance finishes playing the audio overlay, the media player instance may be saved for a next audio overlay for this media asset or another media asset.

One or more additional audio time slots of the media asset may be processed in a similar manner. For example, a second audio time slot of the media asset may have a second original audio content that may be replaced with a generated audio overlay according to metadata of the media asset or according to metadata of the second original audio content. Metadata may be associated with a time slot of the media asset or with default audio content. For example, the media asset may comprise no default or original audio content for one or more time slots of a media asset. Metadata pertaining to the time slot may describe the audio overlay that is to be generated for the time slot, a repetition parameter for the audio overlay for the time slot and the like. A second media player instance may be accessed in the media player pool or may be instantiated as needed for playing a second alternative audio overlay for the second time slot of the media asset.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

Unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not imply that the feature is necessary. Inclusion of the phrase “in some embodiments” does not imply that the feature is not applicable to other embodiments or even all embodiments.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

The systems and/or methods described above may be applied to, or used in accordance with, other systems and/or methods. In various embodiments, additional elements may be included, some elements may be removed, and/or elements may be arranged differently from what is shown. Alterations, modifications, combination, and variations may be effected to the particular embodiments by those of skill in the art without departing from the scope of the present application, which is defined solely by the claims appended hereto. Throughout the specification, the phrases “in response to” and “based on” shall be understood to have a broad meaning unless context requires otherwise. For example, “in response to” may refer to a step that is in direct or indirect response to a prior step, and “based on” may refer to a step that is based at least in part on a prior step or on another factor.

1. A system comprising:
a client device associated with a profile and comprising a memory and control circuitry, wherein the control circuitry is configured to:
receive, from a server, a media asset comprising a first audio portion and a second audio portion;
receive, from the server, metadata related to the media asset, wherein the metadata indicates a first start time and a first end time for the first audio portion within the media asset, and wherein the metadata indicates a second start time and a second end time for the second audio portion within the media asset, and to store the metadata in the memory;
determine to play a modified version of the media asset comprising a first audio overlay and a second audio overlay based at least in part on determining that the media asset has played at the client device or another device associated with the profile at least a threshold number of times, and wherein the first and second overlays are based at least in part on features of the first and second audio portions, respectively;
play a modified version of the media asset by:
playing by a first audio player instance the first audio overlay at the first start time indicated in the metadata, wherein the first audio player instance is accessed in an audio player pool managed at the client device, and wherein the audio player pool comprises a plurality of audio players instances; and
playing by a second audio player instance the second audio overlay at the second start time indicated in the metadata, wherein the second audio player instance is accessed in the audio player pool.

2. The system of claim 1, wherein the second audio player instance is instantiated based at least in part on determining that the second start time occurs between the first start time and the first end time.

3. The system of claim 1, wherein, for each respective audio player instance in the audio player pool, after the respective audio player completes playing a respective audio overlay, the respective audio player instance remains accessible from the audio player pool for subsequent use for the media asset.

4. The system of claim 1, wherein the first and second audio player instances are instantiated based at least in part on determining that the playing of the modified version of the media asset started prior to receiving at least one of the first audio overlay or the second audio overlay.

5. The system of claim 1, wherein at least one of the first audio overlay or the second audio overlay is retrieved from storage of the client device.

6. The system of claim 1, wherein playing the modified version of the media asset further comprises playing a third audio overlay, wherein the third overlay is also included in the media asset prior to the modifying of the media asset.

7. A system comprising:
a server comprising a memory and control circuitry configured to:
provide, to a client device associated with a profile, a media asset comprising a first audio portion and a second audio portion;
provide, to the client device, metadata related to the media asset, wherein the metadata indicates a first start time and a first end time for the first audio portion within the media asset, and wherein the metadata indicates a second start time and a second end time for the second audio portion within the media asset; and
determine to play a modified version of the media asset comprising a first audio overlay and a second audio overlay, wherein the first and second audio overlays are provided from the server to the client device based at least in part on determining, according to data stored in the memory, that the media asset has played at the client device or another device associated with the profile at least a threshold number of times, and wherein the first and second overlays are based at least in part on features of the first and second audio portions, respectively;
wherein the client device is configured to play a modified version of the media asset by:
playing by a first audio player instance the first audio overlay at the first start time indicated in the metadata, wherein the first audio player instance is accessed in an audio player pool managed at the client device, and wherein the audio player pool comprises a plurality of audio players instances; and
playing by a second audio player instance the second audio overlay at the second start time indicated in the metadata, wherein the second audio player instance is accessed in the audio player pool.

8. The system of claim 7, wherein the system is configured to:
access a style attribute of an audio content of the media asset; and
generate, using one or more trained generative machine learning (ML) models, the audio overlay based at least in part on the style attribute of the audio content.

9. The system of claim 8, wherein the style attribute comprises a descriptive key word, wherein the descriptive key word is used as part of an input vector for the one or more ML models.

10. The system of claim 7, wherein the system is configured to:
determine a style attribute of the first audio portion of the media asset by audio feature extraction from the first audio portion of the media asset.

11. The system of claim 7, wherein the system is configured to:
access a repetition threshold indicating a number of times the media asset is to be transmitted unmodified to the client device;
access a repetition parameter indicating a number of times the media asset has been transmitted unmodified to the client device; and
determine, based on the repetition threshold and the repetition parameter, to modify the media asset.

12. The system of claim 11, wherein the repetition parameter indicates a second number of times the media asset is to be caused to be played with the first audio overlay for the media asset, and wherein the system is configured to:
determine, based at least in part on the second number of times, to retrieve another audio overlay for the media asset; and
retransmit to the client device the media asset and the other audio overlay, wherein the other audio overlay is played by the client device based at least in part on the first start time and the first end time.

13. The system of claim 7, wherein the system is configured to:
access in metadata associated with the media asset:
a repetition parameter indicating a number of times the media asset is to be transmitted unmodified to the client device,
a repetition threshold indicating a number of times the media asset has been transmitted to the client device, and
a style attribute indicating a content description of the first audio portion in the media asset in an unmodified state.

14. The system of claim 7, wherein the system is configured to:
determine user engagement with the transmission; and
based at least in part on the determined user engagement, select for causing to be played according to the first start time and the first end time, the first audio portion, the first audio overlay, or another audio overlay.

15. A method comprising:
receiving by a client device, from a server, a media asset comprising a first audio portion and a second audio portion, wherein the client device is associated with a profile;
receiving, from the server, metadata related to the media asset, wherein the metadata indicates a first start time and a first end time for the first audio portion within the media asset, and wherein the metadata indicates a second start time and a second end time for the second audio portion within the media asset;
determining to play a modified version of the media asset comprising a first audio overlay and a second audio overlay based at least in part on determining that the media asset has played at the client device or another device associated with the profile at least a threshold number of times, and wherein the first and second overlays are based at least in part on features of the first and second audio portions, respectively;
playing a modified version of the media asset by:
playing by a first audio player instance the first audio overlay at the first start time indicated in the metadata, wherein the first audio player instance is accessed in an audio player pool managed at the client device, and wherein the audio player pool comprises a plurality of audio players instances; and
playing by a second audio player instance the second audio overlay at the second start time indicated in the metadata, wherein the second audio player instance is accessed in the audio player pool.

16. The method of claim 15, wherein the second audio player instance is instantiated based at least in part on determining that the second start time occurs between the first start time and the first end time.

17. The method of claim 15, wherein, for each respective audio player instance in the audio player pool, after the respective audio player completes playing a respective audio overlay, the respective audio player instance remains accessible from the audio player pool for subsequent use for the media asset.

18. The method of claim 15, wherein the first and second audio player instances are instantiated based at least in part on determining that the playing of the modified version of the media asset started prior to receiving at least one of the first audio overlay or the second audio overlay.

19. The method of claim 15, wherein at least one of the first audio overlay or the second audio overlay is retrieved from storage of the client device.

20. The method of claim 15, wherein the playing the modified version of the media asset further comprises playing a third audio overlay, wherein the third overlay is also included in the media asset prior to the modifying of the media asset.

21-70. (canceled)
